(19) United States
(12) Patent Application Publication
(10) Pub. No.: US 2014/0257989 A1
(43) Pub. Date: Sep. 11, 2014

(54) METHOD AND SYSTEM FOR SELECTING IN-VEHICLE ADVERTISEMENT

(71) Applicant: FORD GLOBAL TECHNOLOGIES, LLC, Dearborn, MI (US)

(72) Inventors: Kwaku O. Prakah-Asante, Commerce Township, MI (US); Perry Robinson MacNeille, Lathrup Village, MI (US)

(73) Assignee: Ford Global Technologies, LLC, Dearborn, MI (US)

(21) Appl. No.: 13/873,966

(22) Filed: Apr. 30, 2013

Related U.S. Application Data
(63) Continuation of application No. 13/789,073, filed on Mar. 7, 2013.

(51) Int. Cl. G06Q 30/02

(52) U.S. Cl. CPC G06Q 30/0266
USPC 705/14.63

(57) ABSTRACT

An advertising system enabling one or more processors to determine and select an in-vehicle drip advertisement. The advertising system may communicate with a vehicle computing system enabling one or more processors to receive input representing a current location. The advertising system may receive input representing a destination and define at least one navigation route corresponding to the current location and the destination. The system may select one or more advertisements based on the at least one navigation route. The system may output the one or more advertisements on an output device at one or more predetermined points on the at least one navigation route. The system may receive an input in response to an advertisement and determine a related advertisement corresponding to the response and the one or more navigation routes. The system may output the related advertisement on the output device.

### CROSS-REFERENCE TO RELATED APPLICATION

This application is a continuation of U.S. application Ser. No. 13/789,073 filed Mar. 7, 2013, the disclosure of which is incorporated in its entirety by reference herein.

### TECHNICAL FIELD

The illustrative embodiments generally relates to a system and method for determining route advertisements.

### BACKGROUND

U.S. Patent Publication 2012/0259541 generally discloses techniques that may be implemented in a mobile electronic device providing navigation functionality to facilitate selection of a route to a destination from multiple route options. In one or more implementations, route selection information is displayed on a display of the mobile electronic device to facilitate selection of a route to a destination. The route selection information describes one or more routes to the destination and includes one or more metrics, associated with each route, that identify a characteristic of the route (e.g., a difficulty rating, topography, total climb distance, number of turns, and so on). A map may then be displayed on the display to furnish navigation information for the selected route to facilitate navigation to the destination.

European Patent 2082190 generally discloses a method for selecting a route for a vehicle fitted with an onboard navigation system, consisting of a step in which a driving style is selected by the driver, a step in which the configurable functions of the vehicle are pre-set according to the selected driving style and a step in which a route is selected that is adapted to said driving style. Preferably the suggested driving styles are selected from a list pre-defined by the manufacturer according to the type of vehicle (sports vehicle, urban vehicle, environmentally friendly vehicle, technological vehicle, etc.).

U.S. Patent Publication 2009/0094635 generally discloses an advertisement system for passenger vehicles. The advertisement system includes at least one advertisement content source that is configured to communicate with a vehicle information system installed aboard the passenger vehicle. When a system user selects viewing content available from the vehicle information system for presentation, the advertisement content source can combine advertising content with the selected viewing content to generate an aggregate play list. During presentation of the aggregate play list, the advertisement system can measure and/or analyze the user response to the presented advertisement content. The advertisement system advantageously can be provided as a part of an overall strategy for managing sales of advertising and providing advertisement-trafficking services via an interactive vehicle information system.

### SUMMARY

In a first illustrative embodiment, an advertising system enabling one or more processors to determine and generate an in-vehicle drip advertisement. The advertising system may communicate with a vehicle computing system enabling one or more processors to receive input representing a current location. The advertising system may receive input representing a destination and define at least one navigation route corresponding to the current location and the destination. The system may select one or more advertisements based on the at least one navigation route. The system may output the one or more advertisements on an output device at one or more predetermined points on the at least one navigation route. The system may receive an input in response to an advertisement and determine a related advertisement corresponding to the response and the one or more navigation routes. The system may output the related advertisement on the output device.

In a second illustrative embodiment, a computer-implemented method receiving one or more input representing a current location and a destination for defining at least one navigation route to the destination. The method may select one or more advertisements based on the at least one navigation route and output the one or more advertisements on an output device. The method may output the one or more advertisements at one or more predetermined points on the at least one navigation route. The method may receive an input in response to an advertisement and determine a related advertisement corresponding to the response and the at least one navigation route. The method may output the related advertisement on the output device.

In a third illustrative embodiment, a non-transitory computer readable medium encoded with a computer program for providing instructions to direct one or more computers to receive input representing a current location and input representing a destination. The computer-implemented medium may define at least one navigation route corresponding to the current location and the destination. The computer program may select one or more advertisements based on the at least one navigation route and outputs the one or more advertisements on an output device. The computer program may output the one or more advertisements at one or more predetermined points on the at least one navigation route. The computer program may receive an input in response to an advertisement and determine a related advertisement corresponding to the response and the at least one navigation route. The computer program may output the related advertisement on the output device.

### BRIEF DESCRIPTION OF THE DRAWINGS

FIG. 1 is an exemplary block topology of a vehicle information system implementing a user-interactive vehicle information display system;

FIG. 2 shows an illustrative example of a learned behavior advertisement platform for a vehicle system;

FIG. 3 shows an illustrative example of a drip marketing advertisement filtering process for a vehicle computing system;

FIG. 4 is a flow diagram illustrating an example process of a vehicle computing system for implementing embodiments of the present invention;

FIG. 5 is a flow diagram illustrating an example process of a vehicle computing system for presenting workload to a vehicle occupant; and

FIG. 6 shows an example of how a drip marketing advertisement process may generate an advertisement strategy.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

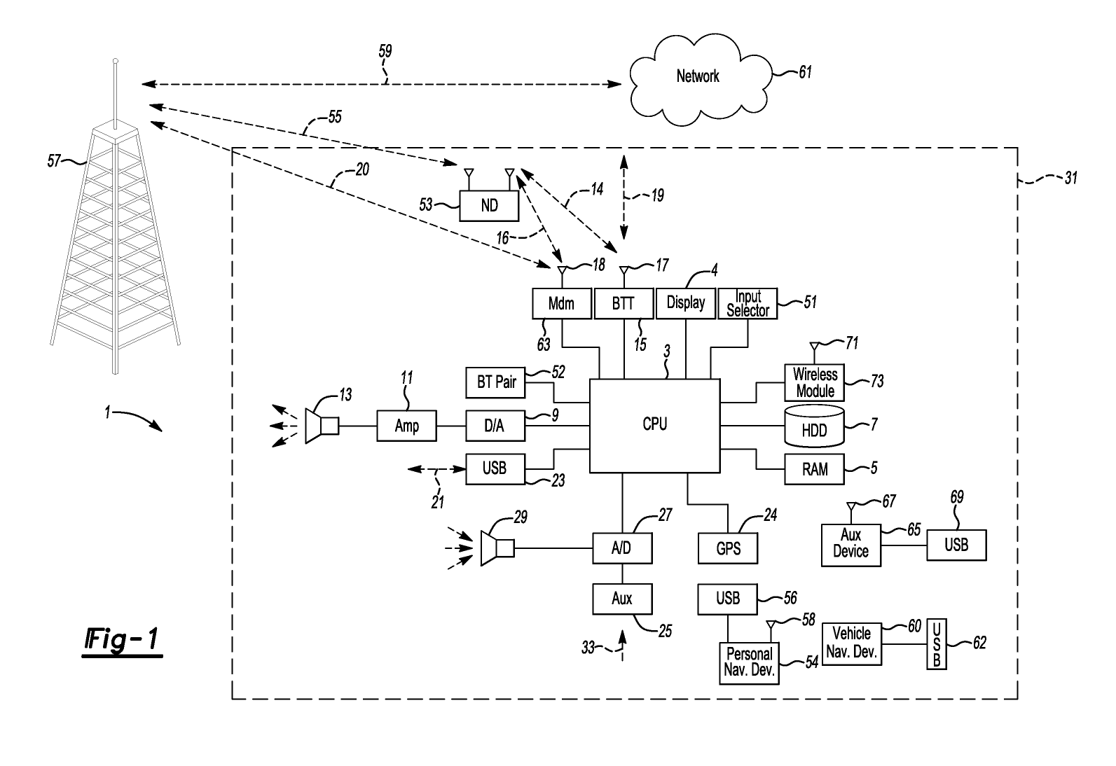

FIG. 1 illustrates an example block topology for a vehicle based computing system 1 (VCS) for a vehicle 31. An example of such a vehicle-based computing system 1 is the SYNC system manufactured by THE FORD MOTOR COMPANY. A vehicle enabled with a vehicle-based computing system may contain a visual front end interface 4 located in the vehicle. The user may also be able to interact with the interface if it is provided, for example, with a touch sensitive screen. In another illustrative embodiment, the interaction occurs through, button presses, spoken dialog system with automatic speech recognition and speech synthesis.

In the illustrative embodiment 1 shown in FIG. 1, a processor 3 controls at least some portion of the operation of the vehicle-based computing system. Provided within the vehicle, the processor allows onboard processing of commands and routines. Further, the processor is connected to both non-persistent 5 and persistent storage 7. In this illustrative embodiment, the non-persistent storage is random access memory (RAM) and the persistent storage is a hard disk drive (HDD) or flash memory. In general, persistent (non-transitory) memory can include all forms of memory that maintain data when a computer or other device is powered down. These include, but are not limited to, HDDs, CDs, DVDs, magnetic tapes, solid state drives, portable USB drives and any other suitable form of persistent memory.

The processor is also provided with a number of different inputs allowing the user to interface with the processor. In this illustrative embodiment, a microphone 29, an auxiliary input 25 (for input 33), a USB input 23, a GPS input 24, screen 4, which may be a touchscreen display, and a BLUETOOTH input 15 are all provided. An input selector 51 is also provided, to allow a user to swap between various inputs. Input to both the microphone and the auxiliary connector is converted from analog to digital by a converter 27 before being passed to the processor. Although not shown, numerous of the vehicle components and auxiliary components in communication with the VCS may use a vehicle network (such as, but not limited to, a CAN bus) to pass data to and from the VCS (or components thereof).

Outputs to the system can include, but are not limited to, a visual display 4 and a speaker 13 or stereo system output. The speaker is connected to an amplifier 11 and receives its signal from the processor 3 through a digital-to-analog converter 9. Output can also be made to a remote BLUETOOTH device such as PND 54 or a USB device such as vehicle navigation device 60 along the bi-directional data streams shown at 19 and 21 respectively.

In one illustrative embodiment, the system 1 uses the BLUETOOTH transceiver 15 to communicate 17 with a user's nomadic device 53 (e.g., cell phone, smart phone, PDA, or any other device having wireless remote network connectivity). The nomadic device can then be used to communicate 59 with a network 61 outside the vehicle 31 through, for example, communication 55 with a cellular tower 57. In some embodiments, tower 57 may be a WiFi access point.

Exemplary communication between the nomadic device and the BLUETOOTH transceiver is represented by signal 14.

Pairing a nomadic device 53 and the BLUETOOTH transceiver 15 can be instructed through a button 52 or similar input. Accordingly, the CPU is instructed that the onboard BLUETOOTH transceiver will be paired with a BLUETOOTH transceiver in a nomadic device.

Data may be communicated between CPU 3 and network 61 utilizing, for example, a data-plan, data over voice, or DTMF tones associated with nomadic device 53. Alternatively, it may be desirable to include an onboard modem 63 having antenna 18 in order to communicate 16 data between CPU 3 and network 61 over the voice band. The nomadic device 53 can then be used to communicate 59 with a network 61 outside the vehicle 31 through, for example, communication 55 with a cellular tower 57. In some embodiments, the modem 63 may establish communication 20 with the tower 57 for communicating with network 61. As a non-limiting example, modem 63 may be a USB cellular modem and communication 20 may be cellular communication.

In one illustrative embodiment, the processor is provided with an operating system including an API to communicate with modem application software. The modem application software may access an embedded module or firmware on the BLUETOOTH transceiver to complete wireless communication with a remote BLUETOOTH transceiver (such as that found in a nomadic device). Bluetooth is a subset of the IEEE 802 PAN (personal area network) protocols. IEEE 802 LAN (local area network) protocols include WiFi and have considerable cross-functionality with IEEE 802 PAN. Both are suitable for wireless communication within a vehicle. Another communication means that can be used in this realm is free-space optical communication (such as IrDA) and non-standardized consumer IR protocols.

In another embodiment, nomadic device 53 includes a modem for voice band or broadband data communication. In the data-over-voice embodiment, a technique known as frequency division multiplexing may be implemented when the owner of the nomadic device can talk over the device while data is being transferred. At other times, when the owner is not using the device, the data transfer can use the whole bandwidth (300 Hz to 3.4 kHz in one example). While frequency division multiplexing may be common for analog cellular communication between the vehicle and the internet, and is still used, it has been largely replaced by hybrids of Code Domain Multiple Access (CDMA), Time Domain Multiple Access (TDMA), Space-Domain Multiple Access (SDMA) for digital cellular communication. These are all ITU IMT-2000 (3G) compliant standards and offer data rates up to 2 mbs for stationary or walking users and 385 kbs for users in a moving vehicle. 3G standards are now being replaced by IMT-Advanced (4G) which offers 100 mbs for users in a vehicle and 1 gbs for stationary users. If the user has a data-plan associated with the nomadic device, it is possible that the data-plan allows for broad-band transmission and the system could use a much wider bandwidth (speeding up data transfer). In still another embodiment, nomadic device 53 is replaced with a cellular communication device (not shown) that is installed to vehicle 31. In yet another embodiment, the ND 53 may be a wireless local area network (LAN) device capable of communication over, for example (and without limitation), an 802.11g network (i.e., WiFi) or a WiMax network.

In one embodiment, incoming data can be passed through the nomadic device via a data-over-voice or data-plan, through the onboard BLUETOOTH transceiver and into the vehicle's internal processor 3. In the case of certain temporary data, for example, the data can be stored on the HDD or other storage media 7 until such time as the data is no longer needed.

Additional sources that may interface with the vehicle include a personal navigation device 54, having, for example, a USB connection 56 and/or an antenna 58, a vehicle navigation device 60 having a USB 62 or other connection, an onboard GPS device 24, or remote navigation system (not shown) having connectivity to network 61. USB is one of a class of serial networking protocols. IEEE 1394 (FireWire™ (Apple), i.LINK™ (Sony), and Lyn™ (Texas Instruments)), EIA (Electronics Industry Association) serial protocols, IEEE 1284 (Centronics Port), S/PDIF (Sony/Philips Digital Interconnect Format) and USB-IF (USB Implementers Forum) form the backbone of the device-device serial standards. Most of the protocols can be implemented for either electrical or optical communication.

Further, the CPU could be in communication with a variety of other auxiliary devices 65. These devices can be connected through a wireless 67 or wired 69 connection. Auxiliary device 65 may include, but are not limited to, personal media players, wireless health devices, portable computers, and the like.

Also, or alternatively, the CPU could be connected to a vehicle based wireless router 73, using for example a WiFi (IEEE 803.11) 71 transceiver. This could allow the CPU to connect to remote networks in range of the local router 73.

In addition to having exemplary processes executed by a vehicle computing system located in a vehicle, in certain embodiments, the exemplary processes may be executed by a computing system in communication with a vehicle computing system. Such a system may include, but is not limited to, a wireless device (e.g., and without limitation, a mobile phone) or a remote computing system (e.g., and without limitation, a server) connected through the wireless device. Collectively, such systems may be referred to as vehicle associated computing systems (VACS). In certain embodiments particular components of the VACS may perform particular portions of a process depending on the particular implementation of the system. By way of example and not limitation, if a process has a step of sending or receiving information with a paired wireless device, then it is likely that the wireless device is not performing the process, since the wireless device would not “send and receive” information with itself. One of ordinary skill in the art will understand when it is inappropriate to apply a particular VACS to a given solution. In all solutions, it is contemplated that at least the vehicle computing system (VCS) located within the vehicle itself is capable of performing the exemplary processes.

Modern location based advertising is designed for delivery to desktop PCs, radio, TVs, and other stationary devices. Typically, the advertising doesn't incorporate spatial filtering, because of, for example, the non-transitory location of the devices. While it may be useful to know, for example, a zip code of a device to which advertising is delivered; little other than that piece of information can be used to target ads to a user. A TV, PC, radio, etc., doesn't typically know, for example, the travel habits of a user; purchasing preferences while traveling, stop times, detour willingness, etc. While it may be useful to deliver a targeted advertisement, even to a stationary device, if this data was known, a television, for example, has little to no means of actually gathering this information.

Vehicle advertisements also can be set up for future delivery, for example, if a route is known. By monitoring a route, advertisement planning can be modified and delivery can be targeted to be spot on based on both a user's preferences and current location. On a long trip, for example, refueling times of day can be known (based, for example, on previously observed behavior and, for example, remaining fuel calculations). Similarly, time for eating can be known based on observed behavior, as well as type of preferred eating for various meals and even specific restaurant preferences. In one example, this can be done using a learning algorithm that anticipates the user's reactions based on prior observations of behavior. The algorithm works by making a suggestion and observing the user's reaction. If the reaction is strongly positive it is reinforced and repeated more often. If it is negative, or indeterminate the test is forgotten. An exploration feature may create new tests when they do not exist or bring back forgotten tests from time to time in case the user's preferences change.

On local trips, advertisements may be provided and related to local businesses, within, for example, a fixed perimeter from or reasonably proximate to a local route. Different business may have different perimeters associated therewith. For example, a user may be willing, based, for example, on observed or input behavior, to travel four miles off route to obtain food, but may only be willing to detour half a mile or less to purchase gasoline or groceries. User input and observed behavior can help determine the particulars in these situations. Additionally, advertisements can be filtered such that trips to the merchants do not add too much time or energy consumption cost to a particular journey.

An automotive spatial filtering device is proposed to support a consumer's long trip and daily commute to filter advertisements and provide them to a consumer. The filter is useful because of the extraordinary growth in the number of advertisements and the ability to gather massive amounts of data using cloud based resources. The filtered advertisements allow for specific advertisements to reach the intended consumer. Utilizing spoken dialogue and user behavior observance, it is possible to learn users' seemingly obscure preferences with syntactic analysis and informational filters.

The filter is able to determine “local” businesses along any sort of route, be it a daily commute or a long haul journey. Long haul trips, for example, may be a route from an origin to a distant destination, which may require one or more meal stops, refueling stops, shopping stops, etc. The filter may also be able to process geographic information that may be of significance. Some people for example, may prefer to do business or stay in locations proximate to golf courses, fishing spots, prefer scenic views, etc. GIS databases, such as, but not limited to, the US Geographical Atlas can provide thousands of geographic entities that can be factored into consideration.

The perimeter around a local commute, for example, can be defined by observed historical information on user behavior that can serve to show what the user considers to be “in range.” Maximum route deviances, typical route deviances, frequency of deviances, etc. can all be used to define perimeters. The deviances can also be more or less time of day specific, and/or can relate to the type of a stop being made. Penalty functions/weightings to businesses not fitting a typical deviance model can be applied to filter advertisements to those most likely acceptable by a user.

Spatial filtering the advertisements may also assign a cost/penalty based on the cost of travel to a location. This can include, but is not limited to, travel costs, travel time, distances, and a travel environment. A preferable location which is only reachable by an undesirable route may be less desirable than slightly less desirable location reachable by a far more desirable route.

Time can also be considered, including time of day. For example, in a long haul journey there could be places a vehicle may stop for lunch, shopping, refueling and sleeping. Hotel advertisements could be filtered based on a predicted stopping/sleeping time, eating advertisements could be based on a predicted eating time. Refueling locations can be based on a vehicle's distance to empty calculation and/or, for example, a driver's tendency to allow fuel to drop below a certain level.

The filter could also be dynamic. It can update during a trip based on a current location and estimated travel speed of the vehicle. Of course, to be most effective, some potentially personal data may need to be used to provide filtering. In at least one example, the process can store personal data on a user's personal computer and access the data from there. Strong private encryption can be used in data transfers, and any data transferred to a cloud based site for processing can be scrubbed of any personal information relating the data to a user identity.

One method of advertising includes the drip method which may be a common method used in electronic information systems. This method may also be effective in vehicle-based advertising, but it is more challenging because access to the customer may be limited by driver workload. In addition, travel on one particular route may not be guaranteed.

In the drip method a series of ads are delivered to an individual prospective customer. Early in the series the ads are fairly non-specific and informative, and generally request a response. For example, a politician may want to draw a crowd at a particular event using e-mail. First informative ads about the planned topics of the event are discussed to get people interested. Individual information is gathered via responses on a blog, etc. The most potent issues for each individual that responds are determined using analytics, and followed by an advertisement for the event stressing these most potent issues.

In order for the drip method to work it may be necessary to know when each prospect can be accessed and how likely it is that they may be inclined and able to take the proposed opportunity. This may allow advertisers to provide fewer ads that are more relevant to listeners and higher value to the merchant, as well as schedule the delivery of advertisements. Also, the actual travel time may be needed to pace the delivery of advertisements.

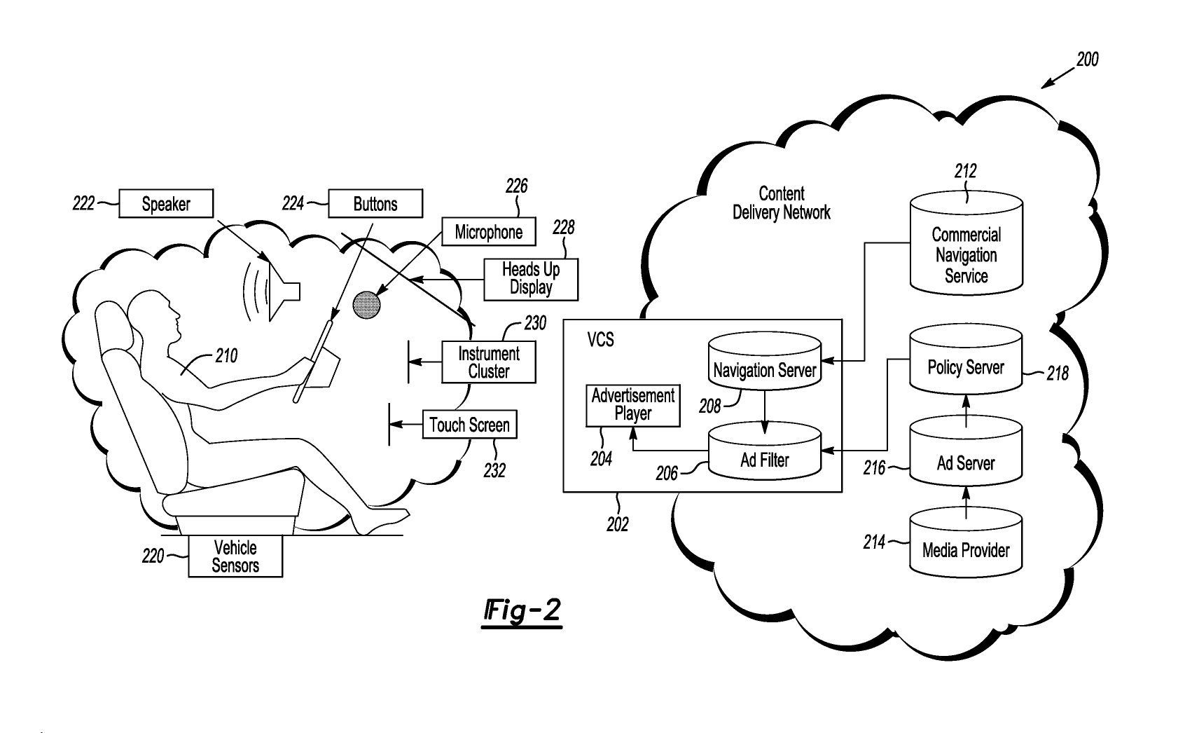

FIG. 2 shows an illustrative example of a learned behavior advertisement system 200 for a vehicle computing system. The learned behavior advertisement system 200 may communicate to a vehicle occupant using the VCS 202 including, but not limited to, the SYNC system. In one embodiment the VCS may communicate with, or integrate an advertisement player unit 204. The advertisement player unit 204 may be in communication with an ad filter 206 to determine the appropriate advertisements while allowing for the system to gather massive amounts of data about the vehicle occupant 210. The massive amount of data about the vehicle occupant may include the biometric data.

A navigation server 208 may provide data to the ad filter including, but not limited to, the determination of the route from an origin to a destination. The route determination provided by the navigation server may allow the advertisement system to understand that there may be one or more stops including, but not limited to meals, refueling of vehicle, and shopping. The navigation server 208 may receive additional information from a commercial navigation service 212. The additional information may provide the navigation system the capability to determine the amount of time needed to reach a destination or a particular maneuver in the route that is used to estimate the availability of the occupant's workload.

The ad filter 206 may use the navigation server 208 for receiving data to make predictions from the route choice to estimate accuracy how likely it is that a particular maneuver may be taken by the vehicle occupant when scheduling a presentation of a drip marketing advertisement. The ad filter may use the received data to determine how available the driver may be to hearing advertisements on a particular maneuver due to the workload of the vehicle occupant.

The ad filter 206 may also receive additional information from one or more servers and databases including, but not limited to a policy server 218, an ad server 216, and a media provider 214. The policy server 218 may provide rules for sequencing the delivery of drip advertisement to the vehicle occupant and guidelines for delivery of the advertisement with route uncertainty and workload restrictions. The ad server 216 may provide may provide additionally personalized drip advertising using location based advertising and workload estimation. The ad server 216 may also develop individual prospective advertisements based on the occupant, and be able to associate those advertisements into drip ads presented in the vehicle to the occupant. The media provider 214 may include one or more advertising firms including, but not limited to, Groupon, Amazon, and Google.

The learned behavior advertising system 200 may be initiated by the VCS using several systems and sensors 220 including, but not limited to, detection of occupant workload, biometrics, occupant behavior, and/or occupant interaction with other vehicle features and systems. The VCS may receive one or more vehicle signals from the several systems and sensors. The selection prediction system may also determine which occupant has entered the vehicle using several technologies including, but not limited to, an occupant's paired wireless device, a user with an associated key, and/or recognition system using a dash mounted camera.

The VCS in conjunction with various sensing capabilities of vehicles are capable of a level of determination of vehicle occupant status previously unseen in modern transportation. Based on detected devices (affiliated with particular users), camera and/or weight sensing devices (which can “recognize” particular users), and a host of other sensors, it is possible to determine, in some instances, precisely which “known” passengers are in a vehicle at a particular time. Even if a given passenger is not known, it may be possible to make some assumptions about the general passenger (such as, for example, the assumption that a 35 lb. passenger is likely a child). In at least one instance, a personalized key present in or used to activate the vehicle can indicate the presence or likely presence of a user associated with the key.

Further, the advertising system 200 may be initiated by measuring the workload, cognitive load, and/or stress level of a driver or other vehicle occupant. Based on observed weather and traffic conditions, a driving profile, driver body temperature, heart rate, and other biometric measurements, assumptions can be made by vehicle processes of how much workload and/or cognitive load a driver or other occupant is currently handling. Additional vehicle sensors may transmit one or more signals to the VCS to calculate a vehicle occupant workload. The vehicle sensors may include, but is not limited to, detection sensor used to monitor occupant's use of vehicle systems and/or use of a wireless device communicating with the VCS (e.g. a sensor detecting incoming phone calls from a mobile phone). For example, the one or more vehicle sensors may determine that the vehicle occupant is adjusting the climate controls in the vehicle and delay the output of an advertisement.

Another example, without limitation, based on the presence of a particular wireless device in a vehicle, and based on readings taken from interior vehicle cameras and seat sensors, a vehicle computing system may recognize that a driver “Jane” and a passenger “Jim” are both in a vehicle. Further, a clock can indicate that it is currently 3:30 AM (meaning, for example, that it is likely dark outside). Weather sensors, a relay indicating that wipers are engaged, and/or cloud-based computing data can indicate that there is currently a hail storm in the vicinity of the vehicle. Cloud-based traffic data can also indicate that the vehicle is currently in moderate traffic. The occupant biometric data may state that Jane may have a high heart rate, while Jim is sleeping. Based on this information, the system can determine a rough approximation of Jane's workload and/or cognitive load (which, in this instance, may be “high”), and, if appropriate within a load tolerance, what, if any, media input request and/or advertisements may be advisable for delivery to Jane and Jim. Other workload and/or cognitive load determinations could include, but are not limited to, signal light enablement, wheel speed, steering angle reversal quantity measurements, etc.

For vehicles equipped with input to vehicle computing systems, OEMs could also provide responsiveness to advertisements. Ads can be skipped, coupons can be requested to be sent to a vehicle or phone, directions to an advertising merchant can be provided, a phone connection to the merchant could be established, etc. Due to the large number of possible vehicle interaction scenarios, many different ways of interacting with advertisements are available. The vehicle occupant 210 may interact with the learned behavior advertisement system with several display and input selection available to the occupant including, but not limited to, an in-vehicle speaker 222, user input buttons 224 on a steering wheel, a microphone 226, a heads up display 228, an instrument cluster 230, and/or a touch screen 232.

Input to an advertising interaction system can be physical or verbal, based on available vehicle controls, and, for example, a vehicle state. For example, it may not be possible to use a touch screen 232 to interact with an advertisement while a vehicle is in motion. For this reason, such advertisements may be blocked, or may only be played in an audio fashion over the in-vehicle speaker 222. Or they could be replaced by advertisements not seeking to have a user provide touch-screen 232 input. The user may provide feedback to the advertisement using a microphone and the system may receive a microphone signal with the occupant's response.

A mode of communication between occupants and a vehicle may rely on spoken dialog, music, tones, sound locality, visuals at small angles from the direction of the road, ambient lighting, haptic and proprioceptic cues, etc. A massive amount of information about a listener's state can be known in a vehicle with the use of several systems and vehicle sensors 220 including, but not limited to, interior vehicle cameras, seat sensors, weather sensors, fuel level sensors, and wheel speed sensors.

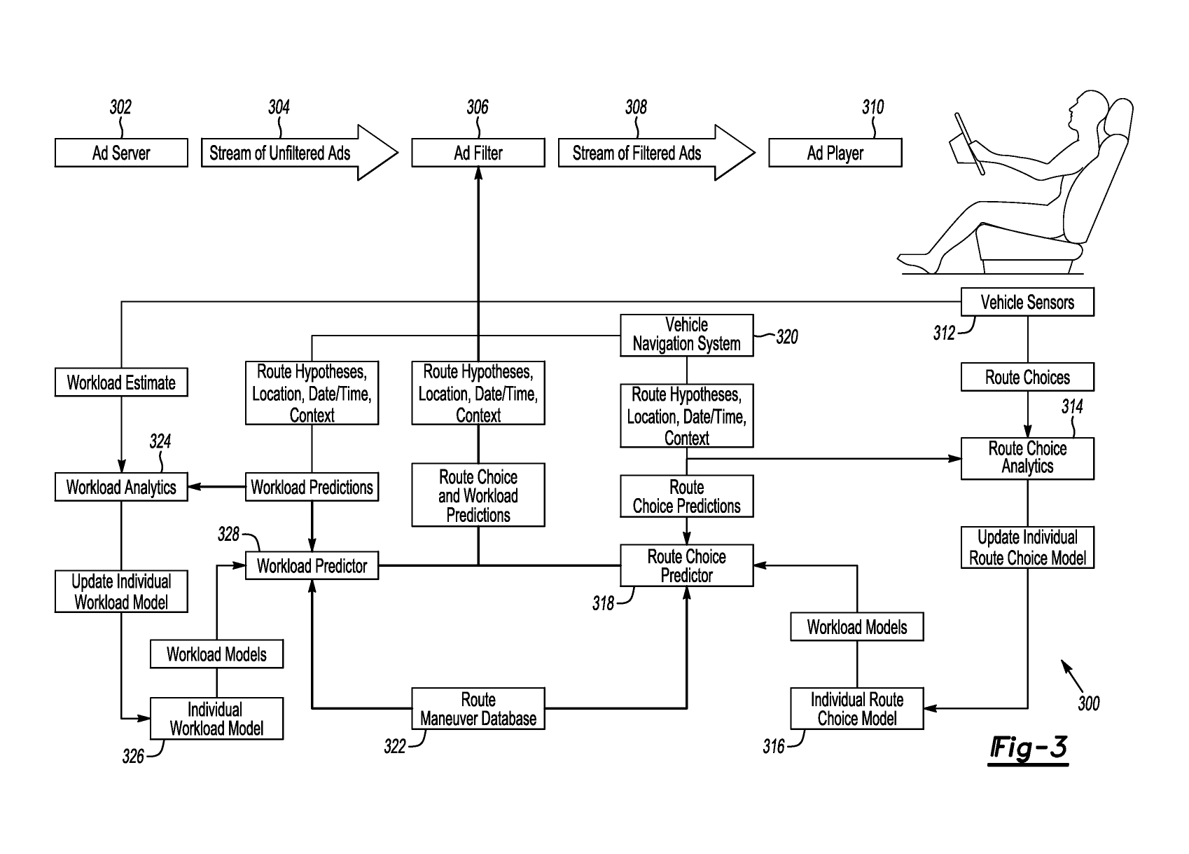

FIG. 3 shows an illustrative example of a drip marketing advertisement filtering process for a vehicle computing system. The drip marketing advertisement filter process may allow for advertisements delivered to a vehicle occupant in response to using analytics from previous ad selections, driving routes, and occupant workload. The drip marketing advertisement filter process communicating with the VCS may be implemented through a computer algorithm, machine executable code, non-transitory computer-readable medium, or software instructions programmed into a suitable programmable logic device(s) of the vehicle, such as the VCS, the entertainment module, other controller in the vehicle, or a combination thereof. Although the various steps shown in the drip marketing advertisement filter flowchart diagram 300 appear to occur in a chronological sequence, at least some of the steps may occur in a different order, and some steps may be performed concurrently or not at all.

At step 302, an ad server may contain advertising information used for communicating and receiving advertisements for distribution to one or more customers. The ad server may transmit a steam of unfiltered ads to an ad filter at step 304. The stream of unfiltered ads may include a variety of advertisements that may not even be intended for each and every recipient of the ad. For example, the unfiltered ads may include an advertisement that may be intended for a mother of children and may be received by a single male with no children.

At step 306, the ad filter may receive the stream of unfiltered advertisements. After receiving the unfiltered data, filtering the advertisements may include one or more of navigation data, date, time, previous advertisement selections made by the occupant, and/or workload parameters. The ad filter may be located within in a vehicle computing system allowing for processing and storing of data in local memory, and/or located in a cloud that may be in communication with a vehicle computing system. In one embodiment the ad filter may be located within the VCS providing fewer advertisements that are more relevant to the vehicle occupant. The stream of filtered ads may provide higher value to the merchant since the scheduled delivery of the ad was placed under conditions acceptable to the occupant during the driving experience at step 308.

The stream of filtered ads is transmitted for outputting the advertisements to an Ad player at step 310. The ad player allows the visual display of retailer advertisements with the use of several output devices including, but not limited to, an in-vehicle LCD screen, an instrument panel, a wireless device located in the vehicle communicating with the VCS using Bluetooth technology, and/or sent to a smart phone via a message. The ad player may also allow for audio output of retailer advertisements using several audio output devices including, but not limited to, in-vehicle speaker system, and/or a wireless device connected to the VCS using Bluetooth technology.

To deliver more relevant ads to the vehicle occupant, the ad filter may receive data that provides the drip marketing advertising filter process to consider the route the occupant may be traveling while predicting the occupant's workload. In one embodiment, vehicle sensors may receive an occupant's route choice using the VCS navigation system, and/or a brought-in navigation device in communication with the VCS at step 312. The brought-in navigation device may include, but is not limited to, a navigation application being run off a smart phone, computer tablet, and/or a portable navigation device. The brought-in navigation device may communicate with the VCS using wireless technology including, but not limited to, Bluetooth technology.

At step 314, the route-choice analytics may be received by the VCS navigation system and/or brought-in navigation device for further analytics. Once one or more route choices have been generated, the one or more choices are transmitted to an individual route choice model at step 316. The individual route choice model may determine the workload an occupant may experience along the route. The route choice model with the related occupant workload may be transmitted to a Route-choice predictor at step 318.

The route-choice predictor may predict which route choice the occupant may travel during a trip, and compares the choice the driver actually does make. The route-choice predictor may receive data from one or more systems and databases including continuous update from the navigation system and route maneuver database.

At step 322, a route-choice predictor may receive stored attributes of route maneuvers to inform the driver of the characteristics of the up-coming route choices from a route maneuver database. For example, the route maneuver database may transmit a message to inform an occupant that “at the intersection ahead you can turn left and go through the business district or you can continue straight to bypass the business district.”

The route-choice predictor may have attributes for maneuvers stored in the route maneuver database, and it correlates them with the individual preferences of the occupants. At step 320, the route-choice predictor may use the correlation to predict which route choice the driver may take at the end of a maneuver, and compares with the choice the driver actually does make using received data from the navigation system. When the prediction is incorrect, the individual preferences are adjusted such that another time they may be correct. This is a learning process that detects the occupant's preferences over time. As enough data is collected that statistics may be applied, the expectation that the route-choice predictor be correct each time is relaxed and occupant preferences are only collected when a statistically significant sample has been collected.

At step 324, a workload analytics may also be employed to predict the occupant's workload during a maneuver. The workload analytics uses the attributes of maneuver choices described above to determine the workload of the occupant on a possible next edge in a route at step 326. The occupant selects a particular route choice allowing the workload predictor to predict the workload the occupants may experience along the maneuver at step 328.

At step 328, the workload predictor may receive data regarding a route maneuver from the route maneuver database. At the end of the maneuver it may take the actual workload from a vehicle's work load estimate (WLE) module and compares it to the predicted workload. This is used to update parameters in the individual workload predictor in much the same way as the route-choice predictor updates the route prediction.

Both the route-choice predictor and the workload predictor may also consider context information that would vary from trip to trip such as time of day, day or year, weather, traffic, etc. Further, both consider the number of times the occupant has been on the route as a measure of familiarity.

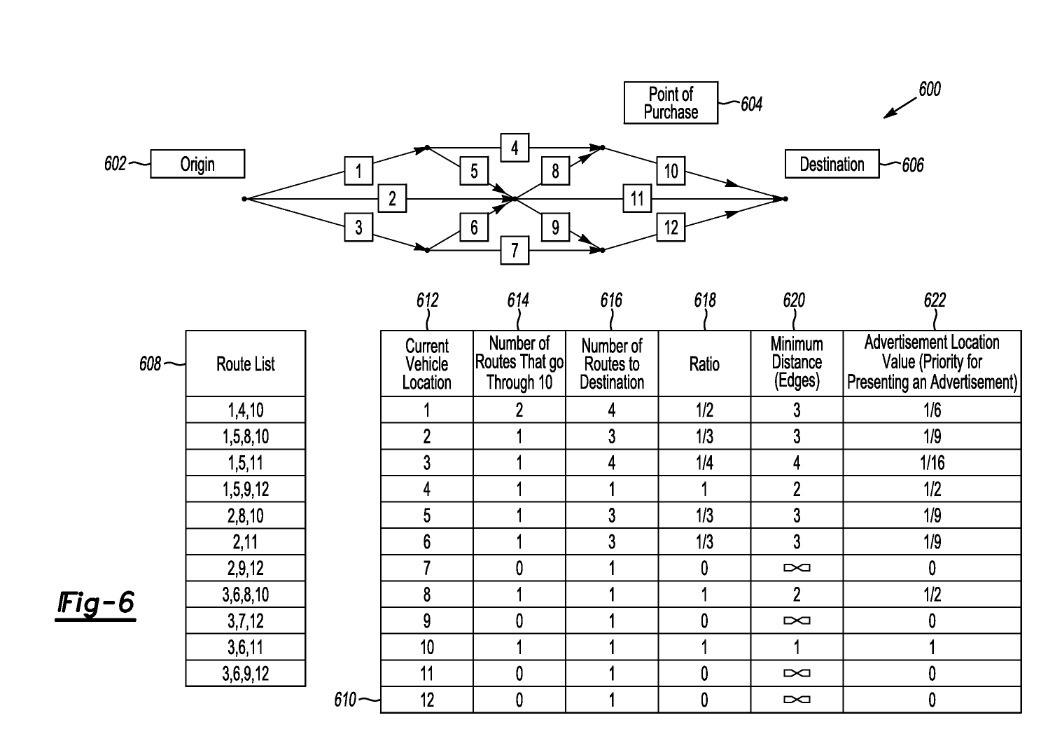

At step 306, the ad filter may receive the route choice predictor and workload predictor data. Using predictions from the route choice and the estimated accuracy of these predictions the advertising filter is able to predict how likely it is that a particular maneuver may be taken and how available the driver will be to hearing advertisements on a particular maneuver due to the workload of the one or more occupants. This is later described in more detail at FIG. 6 where all edges and/or routes are also maneuvers. The navigation system is also able to determine the amount of time needed to reach a particular maneuver.

With the information provided, the ad filter is able to implement a drip advertising strategy. For example, with such a drip advertising strategy the ad filter might determine there is a 50% chance a driver in Philadelphia would pass Wanamaker's on the way to Market street station. Being some distance away, the first advertisement for Wanamaker's could be a brief message about the grandness of pipe organs and especially the one at Wanamaker's. The next ad might discuss Wanamaker history being the first department store to offer cash refunds to customers dissatisfied with their purchases, how the first price tags were used there and how it was the first department store with a restaurant. As an occupant comes closer to Wanamaker's, the drip advertising filtering process might output the advertisements such as “If you take the next left you can have lunch at historic Wanamaker's and listen to the pipe organ while you dine.”

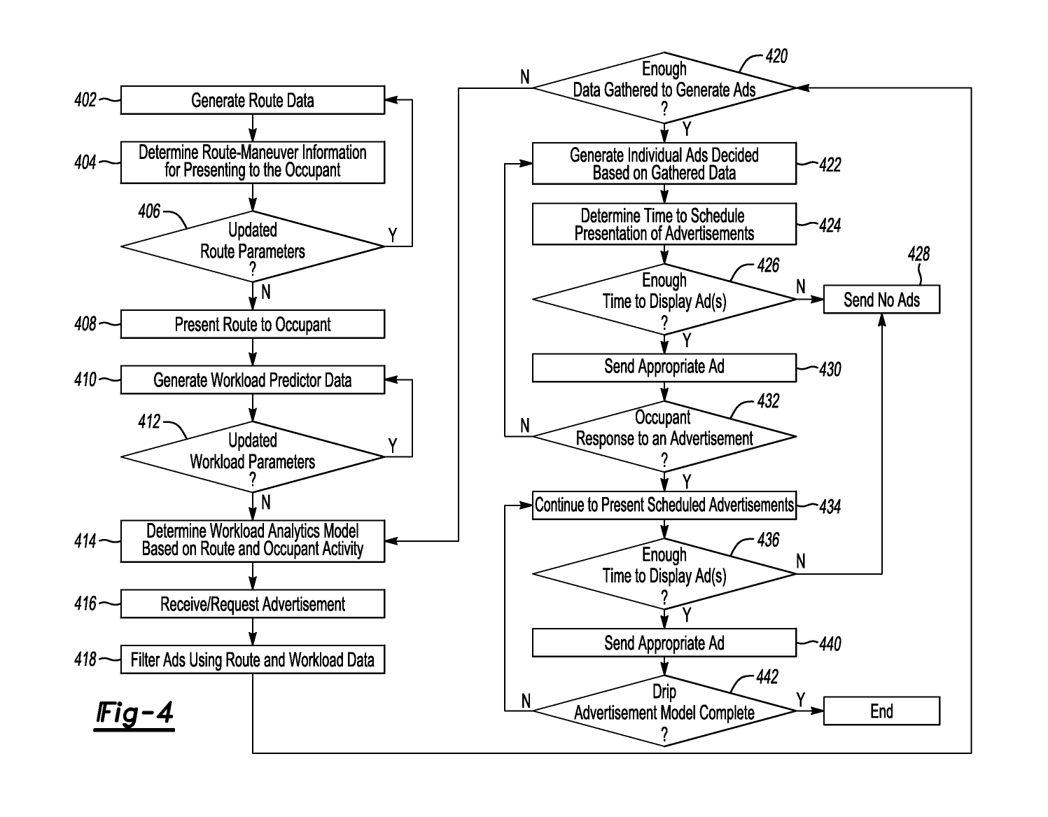

FIG. 4 is a flow diagram illustrating an example process of a vehicle computing system for implementing embodiments of the present invention. In this illustrative example, occupant route selection and workload determination may be used to determine which advertisements to play. The workload determination may be based on the route chosen by the occupant and contextual information. The contextual information may include, but is not limited to, passenger identity, time of day, weather, traffic, environmental data, vehicle state data, etc. This information can be passed directly to a VCS, or to an OEM server which can process the information and send it out to the VCS.

At step 402, the VCS generates the route-maneuver predictor result which may include a prediction calculation using one or more of the data received from the route-maneuver database, individual model database, the vehicle sensors and the navigation system. The VCS may determine the route-maneuver using an on-board navigation system, and/or an off-board brought in navigation device in communication with the VCS. The VCS may define a navigation route based on the current location of the vehicle and a selected destination. The defined navigation route may also include a route choice prediction to determine route maneuver calculations.

The VCS may determine route-maneuver information for presentation to the occupant at step 404. The determination may include route-maneuver analytics for computing model accuracy statistics and updated individual model database parameters using actual route decisions detected by the navigation system and vehicle sensors. The determination of which route-maneuver to present may include, but is not limited to, the preparation of audio instructions and visual graphics of the route presented to the occupant.

At step 406, the VCS may continually update the route-choice predictor based on road selection taken by occupant. The system may update route data based on updated route parameters using received data from the navigation system and/or vehicle sensors. For example, if the occupant decides to take an unexpected turn off the predicted route, the system may update route parameters based on the turn while recalculating/generating route data at step 402.

At step 408, the VCS may present the route-maneuver to an occupant over several output devices including, but not limited to, a graphical map presented on a touch screen, audio instruction over speakers, and/or on a wireless device. The wireless device may include, but is not limited to, a smart phone, computer tablet, and/or a laptop.

At step 410, the system may generate data for a workload predictor based on the route-selection taken by the occupant. The workload predictor may determine predicted workload values of occupant activity using one or more elements from the route-maneuver database, the individual model database, the vehicle sensors and the navigation system. The VCS may continually update the workload values and/or parameters based on updated route parameters using received data from the navigation system and/or vehicle sensors at step 412. For example, if a new route is detected, the VCS may develop new parameters based on the new route and occupant biometric data while generating a new workload predictor based on the new parameters at step 410.

At step 414, the system may determine workload analytics by computing model accuracy statistics and updating individual model database parameters using actual route decisions detected by the navigation system and vehicle sensors. The workload analytics may include, but is not limited to, the estimate of how much driving demand, activity, and stress the occupant may endure on that particular vehicle route. For example, the workload analytic for a particular vehicle route may include the number of stop sign, the number of turns, the number of traffic lights, road gradient, and/or statistical traffic information. The workload analytics may be presented to an occupant using an output device.

At step 416, the system may receive advertisements from an ad server. The ad server may provide a stream of advertisements at the request of a media server. The media server may be in communication with the VCS. The ad server may also provide particular advertisements based on a request directly from the VCS.

The VCS may process the received advertisements using an ad filter at step 418. The ad filter receives the advertisements from the ad-server and analyzes the advertisements based on more or more data elements from the workload prediction for each route-maneuver choice made by the occupant. Route-choice prediction for each possible maneuver may include, but is not limited to route hypothesis, location, date/time and context information from the vehicle navigation and vehicle sensors systems. The ad filter may determine if enough data has been gathered to generate specific advertisements for a drip advertisement model at step 420. The system may receive data to generate particular advertisements based on one or more elements including, but not limited to, the recognized occupant, route selected, and context variables. If the data is insufficient to generate particular advertisements, the system may request additional information at step 414.

At step 422, based on the received data and occupant inputs at the VCS, the ad filter may schedule a series of selected advertisements for a drip advertising model. The system may predetermine points of time to schedule presentation of advertisements included in the drip advertising model at step 424. The generating of predetermined points of time to schedule the presentation of advertisements may include consideration of, but is not limited to, workload analysis, route selection, and recognized occupant. For example, the drip advertising model may present one or more advertisements during a time when the VCS recognizes the presence of an occupant, workload is low on the occupant, and the advertisement correlates with a business/product/service on the selected route.

At step 426, the system may determine if the scheduled predetermined amount of time for the presentation of one or more advertisements may be presented in enough time before a particular maneuver in a selected route that has been determined to potentially cause a high workload on the occupant. If the scheduled predetermined amount of time is not enough to present the advertisement, the system may send no advertisement for display to an occupant at step 428. If the system recognizes that the scheduled time is enough for presentation of one or more advertisements in the drip advertisement model, then the system may send the appropriate advertisement to the output device at step 430. The system may also determine whether to display and/or postpone an advertisement transmitted to an output device based on a predetermined threshold related to workload. If the system detects that the workload value is higher than the predetermined threshold, it may postpone the output of the advertisement. The output device may include, but is not limited to, an instrument panel, center console telematics screen, and/or smart phone device communicating with the VCS using Bluetooth technology.

At step 432, the system may respond whether or not an occupant responds to a presented advertisement. An occupant may respond in several ways to an advertisement including, but not limited to, requesting for more information related to the advertisement, and/or driving closer to the business presented in the advertisement. The requesting for more information related to the advertisement may be accomplished by using occupant control buttons on the output device, voice initiated instruction using a microphone integrated with the VCS, and/or hand movements detected by a dash mounted cameras. If the occupant does not respond to a particular advertisement, the system may generate an updated drip advertisement model at step 422.

At step 434, if the occupant responds to an advertisement, and/or continues to head on the selected route towards the advertised business/product/service then the system may continue to present related advertisements developed in the drip advertisement model. The system may continue to monitor if enough time is present for the presentation of the advertisement based on several elements including, but not limited to occupant workload. If enough time is present the system may output the advertisements and/or may allow continued presentation of the advertisement if the occupant workload value is below the predetermined threshold at step 440. If not enough time is present, and/or the occupant workload value is above the predetermined threshold, the system may avoid sending the advertisement at step 428.

At step 442, the system may continue to present the drip advertisement model developed for the occupants selected route. If the drip advertisement model may present the scheduled advertisements at step 434. If the drip advertisement model is complete and/or the route selected is accomplished, the advertisement campaign based on that selected route and workload analysis may end.

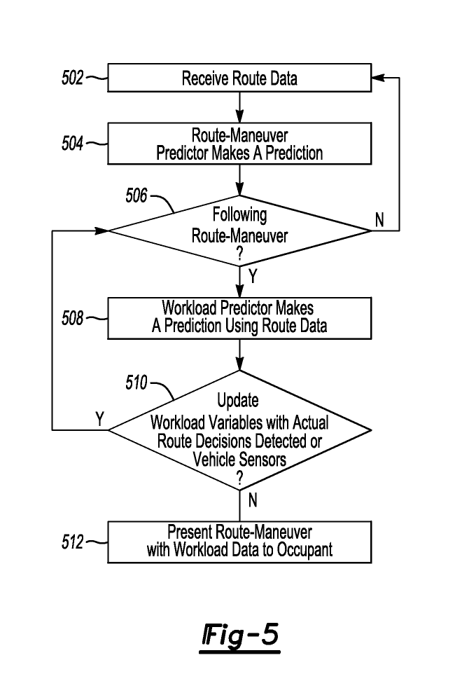

FIG. 5 is a flow diagram illustrating an example process of a vehicle computing system for presenting workload to a vehicle occupant. The workload estimator provides vehicle occupants information about the amount of maneuvering and driving demand the selected route may require. The amount of maneuvering may include, but is not limited to the amount of stop signs, traffic lights, pedestrian crossings, and/or traffic flow related to a selected route. This information may be provided to the vehicle output with messages present on an output device including, but not limited to, on-board LCD screen, audibly over the vehicle speakers, and/or on an occupant's wireless device.

At step 502, the system may receive route data by having an occupant selecting a route on a navigation device. The navigation device may include, but is not limited to, an embedded navigation system within the VCS, and/or a brought-in device that is connected to the VCS. An example of route data may be an occupant selecting a destination including, but not limited to, a business name, a friend's home address, and/or a geographic coordinates. The system may receive data real-time using several vehicle systems and sensors to provide an occupant with navigation information without receiving destination data.

At step 504, the VCS may determine and predict route-maneuver information by using route-maneuver analytics for calculating actual route decisions detected by the navigation system and vehicle sensors. The system may also predict a route using vehicle sensors and/or navigation data generated while the vehicle is moving. The system may continuously monitor to see if the vehicle is following a selected route, and/or a route maneuver at step 506. If the vehicle deviates from the route maneuver or selected route, the system may update the route data at step 502.

At step 508, the workload predictor makes a prediction using route data from one or more of a route-maneuver database, vehicle sensors, and the navigation system. The workload predictor makes a determination of the amount of driving demand and stress that may be put on an occupant based on the selected or predicted route. The amount of driving demand and stress may include, but is not limited to the number of stops, traffic lights, intersections, the number of lanes in the road, and/or the amount of traffic. The system may continuous update the workload variables by monitoring the actual route decisions detected by the navigation system and/or vehicle sensors at step 510. If the system detects a change in the route, the workload variables request the system to determine if the route data requires an update at step 506.

At step 512, the route-maneuver with workload data to present may include, but is not limited to, audio instructions and visual graphics of the route presented to the occupant. The workload data may include, but not limited to, the number of stop signs, detours, intersections, and pedestrian walkways on a route. The workload data may be presented visual, audibly, graphically, and/or in text. The system may also include workload data when providing an occupant with a list of selections for particular route choices based on, but not limited to, being the fastest route, a scenic route, less traffic, and/or less workload.

The workload data may be used to determine when to present advertisements to an occupant. It may be determined the time to present an advertisement to a vehicle occupant may be at a time of low workload. Low workload may be defined as less stress on an occupant including, but not limited to, a minimum amount of stop signs present in the route, and/or a low number of traffic lights present. A high workload may be considered a time when an advertisement should not be presented. A high workload may include, but is not limited to, an occupant being in stop and go traffic, and/or an occupant in an area where there are pedestrian crosswalks.

FIG. 6 shows an example of how a drip marketing advertisement process may generate an advertisement strategy. The route hypotheses 600 may determine what type of advertisement to play based on graph distance of where the occupant origin 602 is located and the route destination 606. The route hypotheses 600 may also demonstrate how the process prioritizes advertisements for a point of purchase based on the arc the vehicle is on. The drip marketing advertisement strategy may communicate advertisements to an occupant based on several factors including, but not limited to, location, route, and timing. Based on one or more factors, the advertising filter is able to predict how likely it is that a particular maneuver may be taken to reach a point of purchase 604.

In the example, the advertisement wanting to be presented may be for a point of purchase 604 situated at location 10 on the route hypotheses 600 chart. The occupant may have started at the origin 602, but the current position of the occupant is at arc 1 on the route. Based on the vehicle being at arc 1, the drip marketing advertisement process may develop a route list 608 to determine the occupant's likelihood of making it to location 10. In the generated route list 608 there are only two routes that may allow the vehicle at arc 1 to pass through location 10 on the way to the destination 606.

The route list 608 data may then be used to determine which advertisement may be presented that has the highest possibility of being effective on the vehicle occupant. The determination of which drip marketing advertisement strategy to take may be based on one or more data logs and tables of analysis. One embodiment of the drip marketing advertisement strategy analysis may include a data log 610 that determines advertisement display value based on current vehicle location 612, number of routes that go through a particular location 614, number of routes to a destination 616, ratio of going through point of purchase 618, distance from point of purchase 620, and the ranking of the advertisement location value 622.

For example, the determination of the drip marketing strategy may be based on a particular advertisement destination corresponding to the number of routes that go through a particular location 614 that may be of interest to the occupant (e.g. point of purchase 604). The calculation of the number of routes that go through a particular location may be accomplished by the process using the current position of the occupant and the destination 606. Once the calculations are complete, the results may be stored on a data log 610. The data log 610 may be used to determine statistical analysis of the probability/ratio the occupant may arrive within proximity of a business/point of purchase 604 before outputting to the occupant the associated advertisement related to that business.

Continuing from our example of having the vehicle currently on arc 1, the combinations that the occupant may go through location 10 may be two possible routes. A ratio 620 may be determined based on several variables including, but not limited to, number of routes that go through a particular location 614 compared to the number of routes to a destination 616. For example, if the vehicle is on arc 3 the priority of displaying a message related to a point of purchase at location 10 may have an advertisement location value of 1/16. However, if the vehicle is on arc 8 then the priority of displaying a message related to a point of purchase at location 10 may have an increased advertisement location value of ½ since the likely hood of passing by location 10 is high.

The advertisement strategy may be determined by the advertisement placement value based on the several factors being calculated in the data log 610. The advertisement location value 622 from the example states that presenting a drip strategy for point of purchase 604 at location 10 may be the best possible solution for this particular route. The advertisement location value 622 provides the drip marketing advertisement process a way of determining the highest potential to generate revenue return from an advertisement while preventing unwanted advertisements from being presented to an occupant.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. An advertising system, the system comprising:
a vehicle computing system having one or more processors configured to:
receive input representing a current location;
receive input representing a destination;
define at least one navigation route corresponding to the current location and the destination;
select one or more advertisements based on the at least one navigation route;
output the one or more advertisements on an output device at one or more predetermined points on the at least one navigation route;
receive an input in response to an advertisement;
determine a related advertisement corresponding to the response and the at least one navigation route; and
output the related advertisement on the output device.

2. The advertising system of claim 1 wherein the one or more processors are additionally configured to:
receive one or more signals corresponding to a vehicle occupant workload; and
output of the one or more advertisements if the vehicle occupant workload is below a predetermined threshold;

3. The advertising system of claim 2 wherein the predetermined threshold is a calculation that includes occupant biometric data.

4. The advertising system of claim 1 wherein the one or more advertisements are received from a database.

5. The advertising system of claim 1 wherein the one or more processors are additionally configured to filter the one or more advertisements based on the navigation route.

6. The advertising system of claim 5 wherein the filter is based on statistical analysis of a number of routes to a particular advertisement destination.

7. The advertising system of claim 1 wherein the input in response to an advertisement is a signal received from a navigation system indicating that the vehicle is in proximity of a business related to the one or more advertisements.

8. The advertising system of claim 1 wherein the input in response to an advertisement is provided by an occupant.

9. The advertising system of claim 1 wherein the one or more processors are additionally configured to receive a microphone signal providing an occupant input to the advertisement.

10. The advertising system of claim 9 wherein the occupant input is provided using a smart phone.

11. A method comprising:
receiving one or more inputs representing a current location and destination;
defining at least one navigation route corresponding to the current location and destination;
selecting one or more advertisements based on the at least one navigation route;
outputting the one or more advertisements on an output device;
receiving an input in response to an advertisement;
determining a related advertisement corresponding to the response; and
outputting the related advertisement on the output device.

12. The method of claim 11 further comprising:
filtering the one or more advertisements during a trip based on the current location and estimated travel speed of a vehicle;
selecting the filtered one or more advertisements based on a calculation of one or more of a previous advertisement selection, driving routes, and occupant workload; and
outputting the one or more advertisements on an output device at one or more predetermined points on the at least one navigation route.

13. The method of claim 12 wherein the one or more of the previous advertisement selection, driving routes, and occupant workload may be stored in local memory or on a server.

14. The method of claim 12 wherein the filtering the one or more advertisements is based on the defined navigation route.

15. The method of claim 14 wherein the filtering is based on statistical analysis of calculating a number of routes to a particular advertisement destination.

16. The method of claim 11 wherein the input in response to an advertisement is a signal received from a navigation system indicating that a vehicle in proximity of a business presented in the one or more advertisements.

17. A non-transitory computer readable medium comprising instruction to direct one or more computers to:
receive input representing a current location;
receive input representing a destination;
define at least one navigation route corresponding to the current location and the destination;
select one or more advertisements based on the at least one navigation route;
output the one or more advertisements on an output device at one or more predetermined points on the at least one navigation route;
receive an input in response to an advertisement;
determine a related advertisement corresponding to the response and the at least one navigation route; and
output the related advertisement on the output device.

18. The non-transitory computer readable medium of claim 17 additionally storing instructions to direct the computer to:
receive one or more vehicle signals corresponding to a vehicle occupant workload; and
output of the one or more advertisements if the vehicle occupant workload is below a predetermined threshold;

19. The non-transitory computer readable medium of claim 18 wherein the predetermined threshold is calculated based on occupant workload.

20. The non-transitory computer readable medium of claim 18 wherein the one or more vehicle signals is based on sensors measuring occupant activity.
